(19) United States
(12) Patent Application Publication
(10) Pub. No.: US 2020/0376666 A1
(43) Pub. Date: Dec. 3, 2020

(54) ROBOT SYSTEM AND OPERATION METHOD

(71) Applicant: ABB Schweiz AG, Baden (CH)

(72) Inventors: Nolwenn Briquet-Kerestedjian, Gif-sur-Yvette (FR); Hao Ding, Heidelberg (DE); Rene Kirsten, Fernwald (DE); Bjoern Matthias, Bad Schoenborn (DE); Pedro Rodriguez, Gif-sur-Yvette (FR); Arne Wahrburg, Darmstadt (DE)

(21) Appl. No.: 16/999,084

(22) Filed: Aug. 21, 2020

Related U.S. Application Data
(63) Continuation of application No. PCT/EP2019/053130, filed on Feb. 8, 2019.

(30) Foreign Application Priority Data
Feb. 23, 2018 (EP) PCT/EP2018/054467

(51) Int. Cl. B25J 9/16; B25J 13/08

(52) U.S. Cl. CPC B25J 9/1674; B25J 17/02; B25J 13/088; B25J 9/161

(57) ABSTRACT

A robot system includes: a robot arm having a plurality of links and joints by which one of the links is connected to another; sensors for determining, for any one of the joints, an angular velocity of the joint and a torque to which the joint is subject; a neural network connected to the sensors, the neural network receiving therefrom angular velocity and torque data, the neural network being trained to distinguish, based on the angular velocity and torque data, between a normal operation condition of the robot arm, a condition in which the robot arm collides with an outside object, and a condition where a person deliberately interacts with the robot arm; and a controller for controlling motion of the robot arm, a mode of operation of which is variable depending on an operation condition signal output by the neural network. One operation mode is a leadthrough mode.

### CROSS-REFERENCE TO PRIOR APPLICATION

This application is a continuation of International Patent Application No. PCT/EP2019/053130, filed on Feb. 8, 2019, which claims priority to International Patent Application No. PCT/EP2018/054467, filed on Feb. 23, 2018. The entire disclosure of both applications is hereby incorporated by reference herein.

### FIELD

The present invention relates to a robot system and to a method of operation therefore.

### BACKGROUND

Robots designed to directly collaborate with humans in a PFL (power and force limited) manner enable safe physical human-robot interaction. In such cases, contacts between humans and the robot are likely. These contacts can be of different kinds, i.e. they can be accidental or they can be intended by the human. In either case, in a robot arm in which several links are interconnected by joints, the contact will cause the angular velocity of at least one joint and/or the torque to which the joint is subject to deviate from an expected value, which may have been measured in a previous iteration of a programmed movement of the robot arm, or which may be calculated based on known weights and leverages of the robot links and a current posture of the robot arm.

Conventionally, any significant deviation from the expected value will cause the robot arm to stop. In that way, if the deviation is due to a collision with the person, injury to the person can be avoided. In a co-operative working environment, a person may deliberately touch the robot, e.g. intending to guide it around a new obstacle that isn't taken account of in a motion program the robot is currently executing. In that case, stopping is not an appropriate reaction to the contact.

It would therefore be desirable if a robot system was capable of distinguishing between accidental and deliberate contact.

An approach to this problem might rely on low-pass and high-pass filtering of joint load torques, based on the assumption that collisions contain more high frequency content and intended interactions contain more low frequency content. However, the classification quality is often not sufficient as other quantities (e.g. joint speed) and features (e.g. shape of rising edges) have to be taken into account for a successful classification. Since many of these quantities are dependent on physical parameters of a given robot, rules on how to take these parameters into account have to be developed individually for different robot models, requiring considerable investment in highly skilled labor.

### SUMMARY

In an embodiment, the present invention provides a robot system, comprising: a robot arm comprising a plurality of links and joints by which one of the links is connected to another; sensors for determining, for any one of the joints, an angular velocity of the joint and a torque to which the joint is subject; a neural network which is connected to the sensors, the neural network being configured to receive therefrom angular velocity and torque data, the neural network being trained to distinguish, based on the angular velocity and torque data, between a normal operation condition of the robot arm, a condition in which the robot arm collides with an outside object, and a condition where a person deliberately interacts with the robot arm; and a controller configured to control motion of the robot arm, a mode of operation of which is variable depending on an operation condition signal output by the neural network, wherein one of the operation modes comprises a leadthrough mode, and wherein the controller enters the leadthrough mode if the neural network finds that a person is deliberately interacting with the robot arm.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a block diagram of a robot system according to the present invention;

FIG. 2 illustrates a data which the neural network of the robot system uses as input;

FIG. 3 is a first embodiment of the neural network;

FIG. 4 is a second embodiment of the neural network; and

FIG. 5 is a third embodiment of the neural network.

### DETAILED DESCRIPTION

In an embodiment, the present invention provides a robot system and a method of operation therefore which provide a simple and economic way of distinguishing between accidental and deliberate contact.

In an embodiment, the present invention provides a robot system comprising

a robot arm comprising a plurality of links and of joints by which one of said links is connected to another, means for determining, for any one of said joints, its angular velocity and the torque to which the joint is subject,

a neural network which is connected to said means for receiving therefrom angular velocity and torque data, and which is trained to distinguish, based on said angular velocity and torque data, between a normal operation condition of the robot arm, a condition in which the robot arm collides with an outside object and a condition where a person deliberately interacts with the robot arm.

In a preferred embodiment, the neural network is trained to determine the point of contact where the robot arm collides with an outside object and/or where a person deliberately interacts with the robot arm.

In a preferred embodiment, the neural network is trained to distinguish, based on said angular velocity and torque data, between a normal operation condition of the robot arm, a condition in which the robot arm collides with an outside object and a condition where a person deliberately interacts with the robot arm and to determine the point of contact where the robot arm collides with an outside object and/or where a person deliberately interacts with the robot arm. Such a point of contact could for example be localised below or above the elbow.

The robot system according to the invention is configured to apply contact classification, and/or contact localization and/or combined classification and localization of contacts.

The robot system according to the invention easily scales to increasing the number of classification outputs. So for instance instead of “normal operation”/“interaction”/“collision” the robot system can be configured to apply a classification such as “normal operation”/“upper arm interaction”/“upper arm collision”/“lower arm interaction”/“lower arm collision”.

If the neural network is trained on a sufficient number of example data representative of the various conditions to be distinguished, specific traits of the various conditions translate into weights of interconnections between the neurons of the network, without the need for a human to actually recognize these traits and to formulate rules. Therefore, a reliable distinction between collision and deliberate contact can be implemented at low cost in diverse robot systems regardless of their physical characteristics.

In order to facilitate a comparison between data sets and recognition of their common or different traits, data which the neural network receives as input in each time step has to have a constant number of elements. However, while a movement of the robot arm proceeds, the amount of data increases continuously. Therefore, the neural network is preferably designed to operate on a time series of angular velocity and torque data pairs of a given joint, wherein, in order to maintain the data set at a constant size, when a new data pair is determined and added to the time series, the oldest pair is deleted.

The data thus obtained may be regarded as similar to video image frames in which e.g. data obtained at a given instant in time at the various joints form a row of pixel data, and a column is formed by successively obtained data of a given joint. In such a data set, recognition of the traits indicative of collision or of deliberate contact is comparable to pattern recognition.

Theoretically, best distinction quality should be achievable if all neurons or at least a large number of the neurons of the neural network receive data from each joint. Therefore, in a basic embodiment of the invention, at least one neuron of the neural network is connected so as to receive angular velocity and torque data of each one of said joints.

However, the more connexions the neurons have, the longer it takes to train the network, or rather, the larger must be the quantity of training data. Therefore, it may be preferable not to allow all neurons to receive data from all over the robot arm, but to associate neurons to a specific joint of the robot. More precisely speaking, at least one neuron of the neural network may be connected so as to receive angular velocity and torque data of an associated one of said joints only.

In practice, each joint of the robot arm may have one or multiple neuron associated to it which receives data only from this one joint.

Specifically, the neural network may comprise a first hidden layer which is divided into a plurality of groups, neurons of a given group being connected so as to receive angular velocity and torque data of an associated one of said joints only, and being unconnected to neurons of other groups.

In that case, a second hidden layer may be provided whose neurons are connected to the various groups in the first hidden layer, so that while the neuron groups of the first hidden layer may recognize traits in the data from a given joint that might be indicative of accidental or deliberate contact, the neurons of the second hidden layer can provide an overview of the entire robot arm.

In a neural network in which each group is associated to one of said joints, each group can be trained individually to distinguish between normal operation of the associated joint, a condition in which the joint collides with an outside object and a condition where a person deliberately interacts with the joint. Since each group of neurons can focus on the data from its associated joint, recognition of traits indicative of a given type of contact tends to be easier for such a group than for a network as defined above, in which neurons can receive data from any joint, so that good training results can be achieved using only a moderate amount of training data.

The robot system may further comprise a controller for controlling motion of the robot arm, the mode of operation of which is variable depending on an operation condition signal output by the neural network.

One of the operation modes of the controller may e.g. be a leadthrough mode, in which the controller, based on the torque and angular velocity data from the joints, detects the direction of a contact force applied to the robot by a person, and controls the robot to move in the direction of this force. Such a switchover will enable the person to e.g. guide the robot arm around an obstacle in its environment of which the controller is not or not yet aware, and thus to prevent a collision with the obstacle.

Another one of the operation modes of the controller may be a normal mode in which the movement of the robot arm is defined by a predetermined program. The controller may enter said normal mode if the neural network finds that deliberate interaction has ended, thus enabling the robot arm to immediately resume normal operation as soon as the person stops guiding it.

The robot system according to the invention can also be configured to classify other types of contact situations. An example for such a contact situation would be a robot performing an assembly task, continuously measuring the position of its tool and the contact forces and moments that occur. From the course of positions as well as forces and moments can then be classified in the robot system according to the invention with the neural network, whether the assembly task was completed successfully. The training of the neural network in the robot system for such a use case is equivalent to the training of the neural network for distinction and/or localization of human-robot contacts, just the input data and the outputs of the network change; in the case described so far: joint moments and velocities in, classification of the contact out, in the second described case: Cartesian position and forces/moments in, classification of the success of the assembly task out.

According to a second aspect of the invention, the above object is achieved by a method of operating a robot system, the method comprising the steps of

a) providing a neural network having a plurality of inputs, each of which is associated to a joint of a robot arm of said system, for receiving torque and angular velocity data of said joint,

b) training said neural network to distinguish, based on said angular velocity and torque data, between a normal operation condition of the robot arm, a condition in which the robot arm collides with an outside object and a condition where a person deliberately interacts with the robot arm based on time series of torque and angular velocity data representative of normal operation, of at least one collision and of a person deliberately interacting with the robot arm;

c) inputting real-time torque and angular velocity data of the robot arm into the neural network in order to determine therefrom an operation condition of the robot arm, and choosing an operation mode of the robot arm based on the operation condition.

In a preferred embodiment, the method further comprises the step of training the neural network to determine the point of contact where the robot arm collides with an outside object and/or where a person deliberately interacts with the robot arm.

In a preferred embodiment, the method further comprises the step of training the neural network to distinguish, based on said angular velocity and torque data, between a normal operation condition of the robot arm, a condition in which the robot arm collides with an outside object and a condition where a person deliberately interacts with the robot arm and to determine the point of contact where the robot arm collides with an outside object and/or where a person deliberately interacts with the robot arm. Such a point of contact could for example be localised below or above the elbow.

The method according to the invention is configured to provide for contact classification, and/or contact localization and/or combined classification and localization of contacts.

The method according to the invention easily scales to increasing the number of classification outputs. So for instance instead of “normal operation”/“interaction”/“collision” the robot system can be configured to apply a classification such as “normal operation”/“upper arm interaction”/“upper arm collision”/“lower arm interaction”/“lower arm collision”.

The method according to the invention can also be configured to classify other types of contact situations. An example for such a contact situation would be a robot performing an assembly task, continuously measuring the position of its tool and the contact forces and moments that occur. From the course of postions as well as forces and moments can then be classified using the method according to the invention with a neural network, whether the assembly task was completed successfully. The method is equivalent to the distinction and/or localization of human-robot contacts, just the input data and the outputs of the network change; in the case described so far: joint moments and velocities in, classification of the contact out, in the second described case: Cartesian position and forces/moments in, classification of the success of the assembly task out.

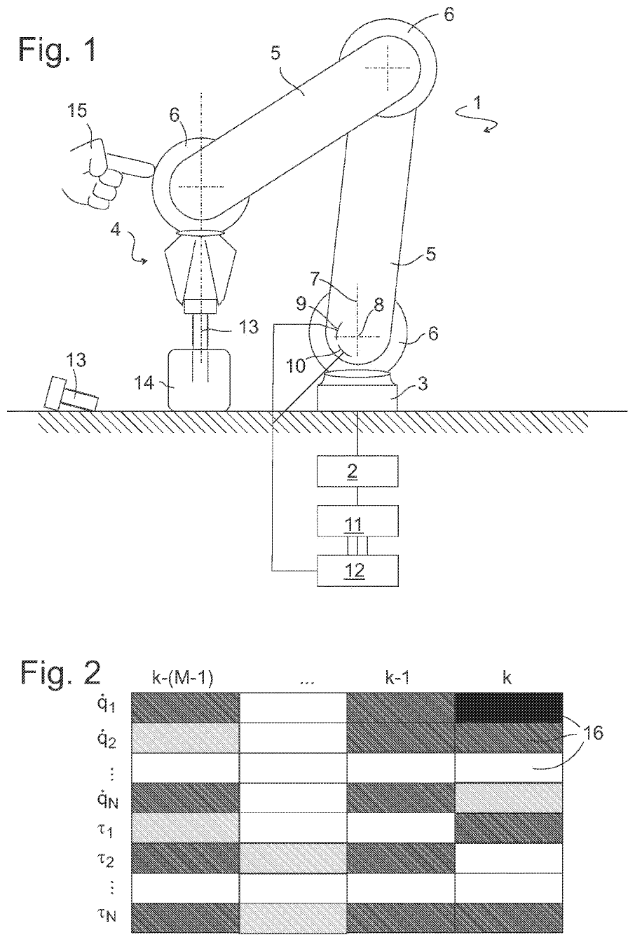

FIG. 1 illustrates a robot system comprising a robot arm 1 and its associated controller 2. The robot arm 1 comprises a support 3, an end effector 4 an arbitrary number of links 5 and joints 6 which connect to the links 5 to each other, to the support 3 or to the end effector 4 and have one or two degrees of rotational freedom. As usual in the art, motors for driving rotation of the links 5 and the end effector 4 about axes 7, 8 are hidden inside the links 5, the joints 6 or the support 3. The joints 6 further comprise rotary encoders or other appropriate sensors 9 associated to each axis 7, 8 which provide the controller 2 with data on the orientation and angular velocity of each link 5, and torque sensors 10 which are sensitive to torque in the direction of axis 7 and 8, respectively. When the robot arm 1 is moving freely, without contact to outside objects, the torque detected by these sensors 10 is governed by the weight and geometry of the links 5, their internal friction and, when the angular velocity is not constant, by their moment of inertia, so that the controller 2, based on known angles and rotational velocities of the links 5, can calculate an expected torque at each joint.

If the torque detected by the sensors 10 deviates significantly from such an expected value, it can be assumed that the robot arm 1 is in contact with some outside object or person. Output data from the sensors 9, 10 are received by a neural network 11, which, in turn, determines an operating mode of controller 2.

A FIFO storage 12 is connected between the outputs of the sensors 9, 10 and the neural network 11, making available to the neural network 11 not only current torque and angular velocity data, but the M most recent sets of data from the sensors 9, 10, wherein M is an arbitrary integer.

The controller 2 has at least three operating modes, namely a normal operating mode in which it controls the robot arm to move according to a predefined program, e.g. so as to seize a screw 13 and to introduce it into a workpiece 14. Another is an emergency stop mode in which the robot arm 1 is immediately brought to a halt, and a third one is a leadthrough mode in which the robot arm 1 will move into a direction into which it is urged by an outside force, e.g. by a user's hand 15.

FIG. 2 is an “image frame” formed by angular velocity and torque data provided by the sensors of robot arm 1. The image frame comprises “pixels” 16, each of which corresponds to one data from one sensor 9 or 10. These pixels 16 are organized in 2N lines, N being the number of degrees of freedom of the robot arm 1 and of angular velocity and torque sensors 9, 10 associated to each of these degrees of freedom, and M columns, each column corresponding to a set of data obtained from said 2N sensors 9, 10 at a given instant in time and stored in the FIFO storage 13.

The task of the neural network 11 is to recognize, in an image frame formed by data from the sensors 9, 10, traits which are characteristic of accidental and deliberate contact, so that when it recognizes accidental contact, it will switch the controller 2 into emergency stop mode, and that, when it recognizes deliberate contact, the controller 2 is switched to leadthrough mode.

The neural network 11 is trained off-line to recognize these traits by inputting training data obtained from the robot arm in normal operation, in case of accidental contact and in case of deliberate contact, and by optimizing coupling coefficients between the neurons of the network in a way known per se, by backpropagation, until the reliability with which these different conditions are recognized by the network 11 is satisfactory.

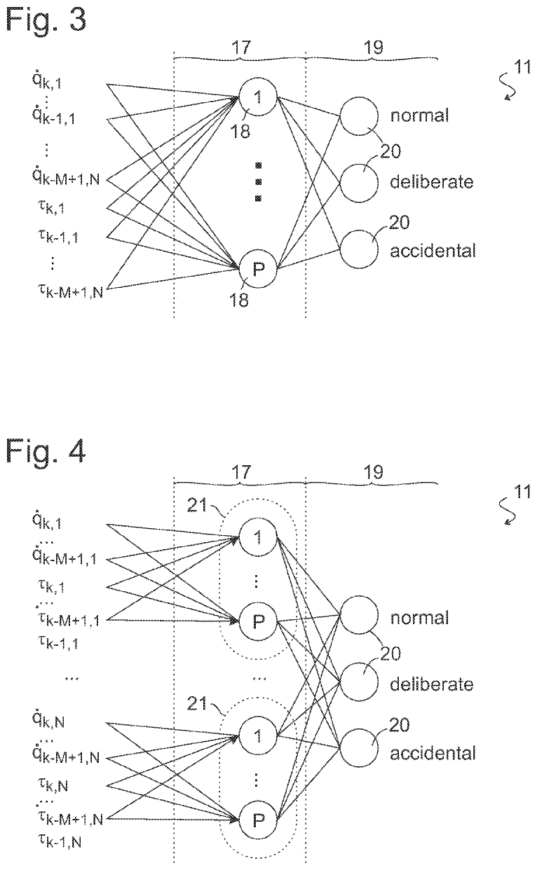

The neural network 11 can have the structure shown in FIG. 3: In a hidden layer 17, there are P neurons 18, each of which receives torque and angular velocity data from the M most recent data sets stored in storage 13, i.e. which is capable of “seeing” every pixel in the frame of FIG. 2. An output layer 19 comprises at least three neurons 20, one for each of the operating modes of controller 2 which the network 11 has to choose from. Each of the neurons 20 receives input from all neurons 18 of hidden layer 17. The neurons 18 in the hidden layer 17 work with a standard sigmoid activation function while the neurons 20 in the output layer 19 use a softmax activation function. Only one of the neurons 20 can be active at a given time. When such a neuron 20 goes active, it switches controller 2 into its associated operating mode.

Since each neuron 18 receives N*M input data, its vector of weighting coefficients must have N*M components, so that the training process involves optimizing P*N*M weighting coefficients. In order to prevent the neural network 11 from simply memorizing its training data and the desired recognition results associated to them, a huge amount of training data is required, and the amount of computation required for satisfactory training increases far faster than in linear proportion with the number N of degrees of freedom of the robot arm 1.

According to a preferred embodiment shown in FIG. 4, the neural network 11 has a structure that reflects the structure of the robot arm 1: the neurons 18 of the hidden layer 17 are divided into N groups 21, each of which is associated to one degree of freedom of the robot arm 1, or to its corresponding joint 5. Neurons of one group 21 receive data only from the angular velocity sensor 9 and the torque sensor 10 of said one joint 5. This reduces the number of weighting coefficients in each neuron 18 by a factor of N. Since each group 21 supervises only one joint 5, the number of neurons needed in one group 21 will be much less than the P neurons of FIG. 3; rather, since the complexity of the task the neural network 11 is to solve is the same in both cases, the total number of hidden layer neurons 18 can be the same in both embodiments. So the amount of computation required for training is reduced not only due to the smaller number of weighting vector components, but also because the amount of training data needed to prevent the network 11 from memorizing is smaller than in the case of FIG. 3.

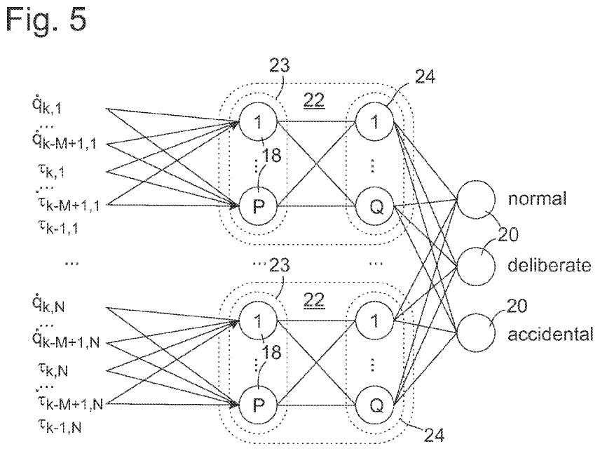

The structure of the network 11 shown in FIG. 5 is modelled on the fact that the effect of a contact, deliberate or accidental, on a given joint 5 depends on where in the robot arm 1 the contact occurred. Any contact will usually have the most noticeable effect on the joints that are immediately adjacent to the link where the contact occurred. Therefore, in a further preferred embodiment, training data are labelled not only as corresponding to normal operation, accidental contact or deliberate contact, but in the latter two cases, they also specify the link in which the contact occurred. For neurons 18 associated to a given joint in the hidden layer 17, it is much easier to recognize a condition in which a contact occurs with a link immediately adjacent to that joint than one where contact occurs with a faraway link. Therefore, in the embodiment of FIG. 5, the network 11 is divided into N sub-networks 22, each of which is associated to one joint or degree of freedom of the robot arm 1. Each sub-network 22 comprises a hidden layer 23 whose neurons 18 receive data from the angular velocity sensor 9 and torque sensor 10 of said joint only, just like those of the groups 21 of FIG. 4. In contrast to these groups 21, however, the sub-networks 22 do not have a common output layer, but each sub-network has an output layer 24 of its own.

Based on training data which indicate a link in which contact occurred, these output layers 24 can be trained to distinguish between normal operation and a condition where a contact, deliberate or accidental, occurred in link adjacent to their associated joint. Since a contact will usually produce the most clearly noticeable effect in a nearby joint, learning its characteristic traits is easier for the sub-network 22 associated to that joint than if faraway contacts had to be taken account of, too. Therefore, a good quality of distinction can be achieved here based on a small amount of training data.

The number Q of neurons in the output layers of the sub-networks 22 can be equal to the number of operating modes of controller 2. Then outputs of these output layers 24 can be used directly for controlling the mode of operation of controller 2. Else a global output layer 25 can be provided whose neurons indicate, for the robot arm as a whole, whether it is operating normally, is in accidental or in deliberate contact. If Q is the number of operating modes, then the neurons of global output layer 25 can be implemented as simple logic gates, e.g. a NOR-gate for normal operation which will output TRUE when none of the sub-networks 22 indicates a contact condition, or gates for accidental and deliberate contact, respectively, which will output TRUE whenever one of the sub-networks 22 detects accidental and deliberate contact at its associated link.

In practice, the number of neurons Q in the output layers 24 of the sub-networks 22 should be somewhat higher than the number of operating modes, in order to enable each sub-network 22 to provide more information to the global output layer 25, e.g. not only whether a contact has occurred or not occurred at an immediately adjacent link but also whether there is a suspicion that a contact might have occurred at a remote link, thereby enabling the global output layer 25 to draw sounder conclusions.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

1 robot arm
2 Controller
3 Support
4 end effector
5 link
6 joint
7 axis
8 axis
9 angular velocity sensor
10 torque sensor
11 neural network
12 FIFO storage
13 screw
14 workpiece
15 hand
16 pixel
17 hidden layer
18 neuron
19 output layer
20 neuron
21 group
22 sub-network
23 hidden layer
24 output layer
25 global output layer

What is claimed is:

1. A robot system, comprising:
a robot arm comprising a plurality of links and joints by which one of the links is connected to another;
sensors for determining, for any one of the joints, an angular velocity of the joint and a torque to which the joint is subject;
a neural network which is connected to the sensors, the neural network being configured to receive therefrom angular velocity and torque data, the neural network being trained to distinguish, based on the angular velocity and torque data, between a normal operation condition of the robot arm, a condition in which the robot arm collides with an outside object, and a condition where a person deliberately interacts with the robot arm; and
a controller configured to control motion of the robot arm, a mode of operation of which is variable depending on an operation condition signal output by the neural network,
wherein one of the operation modes comprises a leadthrough mode, and
wherein the controller enters the leadthrough mode if the neural network finds that a person is deliberately interacting with the robot arm.

2. The robot system of claim 1, wherein the neural network is configured to operate on a time series of angular velocity and torque data pairs of a given joint, and
wherein, when a new data pair (\dot{q}_{k,i},τ_{k,i}) is determined and added to the time series, the oldest pair (\dot{q}_{k+M,i},τ_{k+M,i}) is deleted.

3. The robot system of claim 1, wherein at least one neuron of the neural network is connected so as to receive angular velocity and torque data (\dot{q}_{k,i},τ_{k,i}, i=1, . . . , N) of each one of the joints.

4. The robot system of claim 1, wherein at least one neuron of the neural network is connected so as to receive angular velocity and torque data (\dot{q}_{k,i},τ_{k,i}) of an associated one of the joints only.

5. The robot system of claim 1, wherein the neural network comprises a first hidden layer which is divided into a plurality of groups, neurons of a given group being connected so as to receive angular velocity and torque data (\dot{q}_{k,i},τ_{k,i}) of an associated one of the joints only, and being unconnected to neurons of other groups.

6. The robot system of claim 1, wherein the neural network comprises groups of neurons, each group being associated to one of the joints and being trained to distinguish between normal operation of the associated joint, a condition in which the joint or an adjacent link collides with an outside object, and a condition where a person deliberately interacts with the joint or the adjacent link.

7. The robot system of claim 1, wherein one of the operation modes comprises a normal mode in which the movement of the robot arm is defined by a predetermined program, and
wherein the controller enters the normal mode if the neural network finds that deliberate interaction has ended.

8. A method of operating a robot system, the method comprising the steps of:
a) providing a neural network having a plurality of inputs, each of which is associated to a joint of a robot arm of the robot system, the neural network being configured to receive torque and angular velocity data of the joint;
b) training the neural network to distinguish, based on the angular velocity and torque data, between a normal operation condition of the robot arm, a condition in which the robot arm collides with an outside object, and a condition where a person deliberately interacts with the robot arm based on time series of torque and angular velocity data representative of normal operation, of at least one collision and of a person deliberately interacting with the robot arm; and
c) inputting real-time torque and angular velocity data of the robot arm into the neural network in order to determine therefrom an operation condition of the robot arm, and choosing an operation mode of the robot arm based on the operation condition.

9. The robot system of claim 1, wherein the neural network is trained to determine a point of contact where the robot arm collides with an outside object and/or where a person deliberately interacts with the robot arm.

10. The method of claim 8, further comprising the step of:
d) training the neural network to determine a point of contact where the robot arm collides with an outside object and/or where a person deliberately interacts with the robot arm.
